(19) United States
(12) Patent Application Publication
(10) Pub. No.: US 2015/0278728 A1
(43) Pub. Date: Oct. 1, 2015

(54) CLAIMS CATEGORIZATION IN A WORKFLOW

(71) Applicant: Mitchell International, Inc., San Diego, CA (US)

(72) Inventors: Vidya Dinamani, San Diego, CA (US); Michael Bishop, San Diego, CA (US); Huey Antley, San Diego, CA (US); James Flagg, San Diego, CA (US); Iris Ren, San Diego, CA (US); Christian Renninger, San Diego, CA (US)

(21) Appl. No.: 14/675,372

(22) Filed: Mar. 31, 2015

Related U.S. Application Data
(60) Provisional application No. 61/973,179, filed on Mar. 31, 2014.

(51) Int. Cl. G06Q 10/06

(52) U.S. Cl. CPC G06Q 10/0633; G06Q 40/08

(57) ABSTRACT

A claim is processed and categorized prior to the assignment of a claims adjuster. The probability that the total amount of medical charges submitted for a claimant within a certain period of time following the date of loss will be below a certain threshold based on a small set of input variables. The input variables and prediction may be communicated to a claims management systems via web service. The claims management system that receives the prediction may be independent of the claims categorization system itself. That is, the user interface to gain access to the claims processing described herein may be independent of the claims processing itself. The prediction is achieved with analysis models that are configured to easily accommodate changes in the input parameters for the model.

### CROSS-REFERENCE TO RELATED APPLICATIONS

This application claims priority to Provisional Application No. 61/973,179 filed Mar. 31, 2014 and titled “Claims Categorization in a Workflow”, the entirety of which is incorporated herein by reference.

### BACKGROUND

This disclosure relates to claims processing for greater efficiency and accuracy of outcomes.

When processing a claim is initiated by an insurance carrier, such as a claim for medical treatment as a result of an instigating event, the claim is typically assigned to a claims adjuster for processing. The experience and skill set of the claims adjuster can affect both the cost of handling the claim and the outcome of the claim. The assignment of a claim to an adjuster is usually performed by the insurance carrier's claims management processing system. The assignment to an adjuster typically occurs immediately after the First Notice of Loss (FNOL), which is the time at which the claimant first makes a claim to the insurance carrier, and is typically performed in an ad hoc manner, such as by assigning a “next adjuster in queue” to the claims or assigning an adjuster who is geographically close to the location of loss, or the like.

The cost and satisfactory outcome of the claim are therefore seen to be dependant on the claims adjuster who is assigned the claim. There is a need for greater efficiency and outcome satisfaction in the processing of claims by adjusters. The present invention satisfied this need.

### SUMMARY

In some aspects, a claim is processed and categorized in a user interface prior to the assignment of a claims adjuster. The probability that the total amount of medical charges submitted for a claimant within a predetermined period of time following the date of loss will be below a predetermined threshold is calculated, comprising a claim severity prediction, based on a small set of input variables. The input variables and claim severity prediction may be communicated to a categorization engine and received in a claims management systems via web service. The user interface and the claims management system that receives the prediction may be independent of the claims categorization system itself. That is, the user interface to gain access to the claims processing described herein may be independent of the claims processing itself. Alternatively, the user interface, categorization engine, and claims management system may be integrated together as a single system. The claim severity prediction is achieved with analysis models that are configured and deployed to easily accommodate changes in the input parameters for the model. Additionally, models may be configured so they vary by state of jurisdiction, by the customer requesting the prediction, and other parameters that may affect the severity prediction.

The final, actual experienced claim outcomes may be collected for comparison with corresponding predictions, as a way of adjusting the prediction models for greater accuracy. The final outcomes are outside the knowledge of this service. A system that calls this service should collect final outcomes and log them in a way so that these outcomes can be joined to their associated predictions recorded by the service, for analysis. For systems configured to call the claims adjustment system and otherwise operate independently of the claims adjustment system, should undertake best efforts to collect outcome data for the analysis.

Other features of the disclosed subject matter will be apparent from the following description of the embodiments, which illustrate, by way of example, the principles of the disclosed subject matter.

### BRIEF DESCRIPTION OF THE DRAWINGS

FIG. 1 is a block diagram of a computer system that provides the features disclosed herein.

FIG. 2 is a flow diagram of the processing performed by the system illustrated in FIG. 1.

FIG. 3 is an exemplary input interface for a user as displayed on a computing device for receiving input in accordance with the system illustrated in FIG. 1.

FIG. 4 is an exemplary report as displayed on a computing device after providing user input for a claim and selecting “generate” on the input screen, in accordance with the system illustrated in FIG. 1.

FIG. 5 is an exemplary report as displayed on a computing device after providing user input for a claim and selecting “generate” on the input screen, in accordance with the system illustrated in FIG. 1.

FIG. 6 is an exemplary report as displayed on a computing device after providing user input for a claim and selecting “generate” on the input screen, in accordance with the system illustrated in FIG. 1, showing a “YES” outcome.

FIG. 7 is an alternate embodiment of the report pages illustrated in FIGS. 3, 4, 5, an 6, showing a “YES” outcome.

FIG. 8 is a block diagram of an embodiment of a computer system constructed in accordance with embodiments of the system illustrated in FIG. 1.

FIG. 9 is a block diagram of an embodiment of a special-purpose computer system constructed in accordance with embodiments of the system illustrated in FIG. 1.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. It will be understood by one of ordinary skill in the art that the embodiments maybe practiced without these specific details. For example, without limitation, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

It is also noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, and the like. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information. The term “computer-readable medium” includes, but is not limited to, portable or fixed storage devices, optical storage devices, wireless channels, and various other mediums capable of storing, containing, or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means, including memory sharing, message passing, token passing, network transmission, and the like.

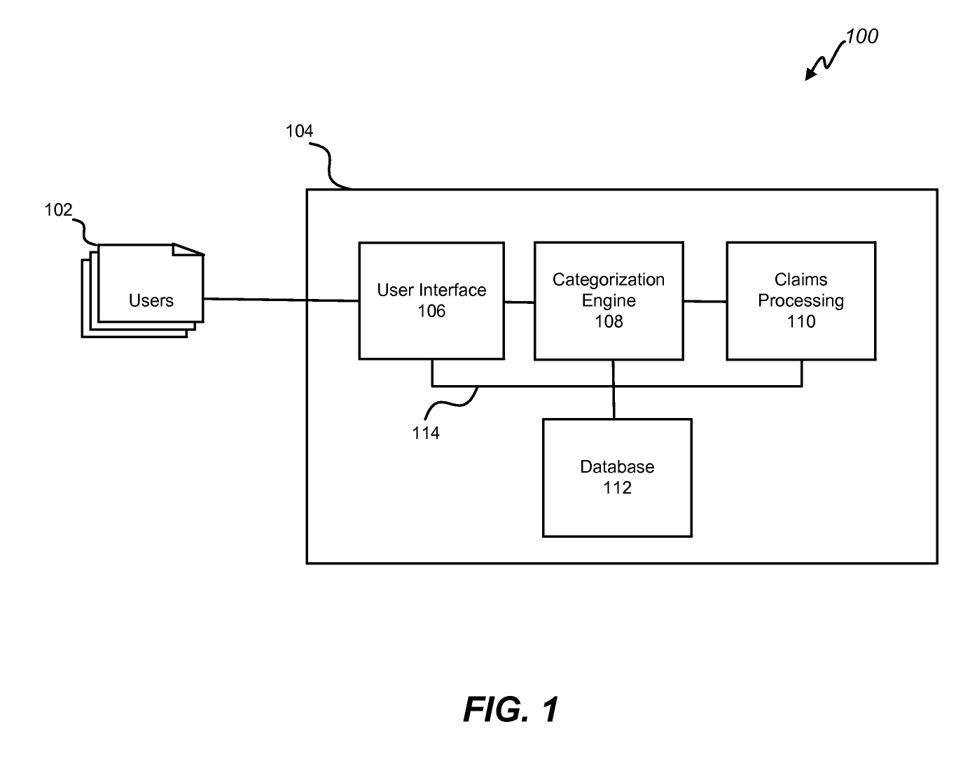

Various embodiments will now be discussed in greater detail with reference to the accompanying figures, beginning with FIG. 1.

FIG. 1 shows a block diagram of an example of a computer system 100 that provides the features disclosed herein. One or more users 102 at respective computer devices communicate with a claims processing system 104 that includes a user interface 106 through which the users enter claims data. The claims data is received through the user interface and is provided to a categorization engine 108 to generate a predicted severity value. The predicted severity value may comprise, for example, a numerical value and/or a categorization such as “severe” or “fast track”, and is used to determine further processing in the claims processing component 110. The claims processing component 110 may, for example, give a claim expedited processing because the claim is predicted to result in a lower claim amount than a predetermined threshold value. Such expedited processing may be categorized as “fast track” or “expedited”, for example. Different categorizations will be paired with corresponding claims adjusters, as selected for efficient processing. Other claims may have a predicted claim value that is greater than the predetermined threshold value, in which case no special processing is invoked by the system. A database 112 stores data that may be accessed by all the system components 106, 108, 110.

The various components of the claims processing system 104 comprise computer systems and may be implemented as one or more independent processing systems, or may be integrated into a single system. In the case of one or more independent processing systems, the respective systems are capable of communicating over a data network 114, such as a closed network and/or a network such as the Internet. In the case of a single system 104, the communication between components 106, 108, 110, 112 may take place over a system bus or other internal communication network.

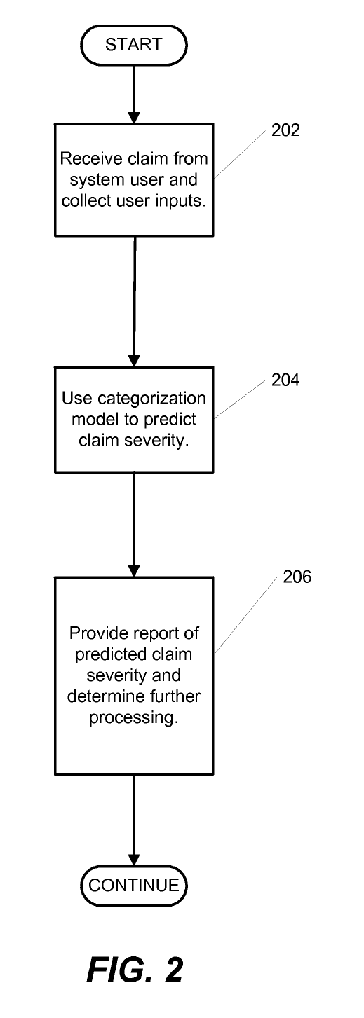

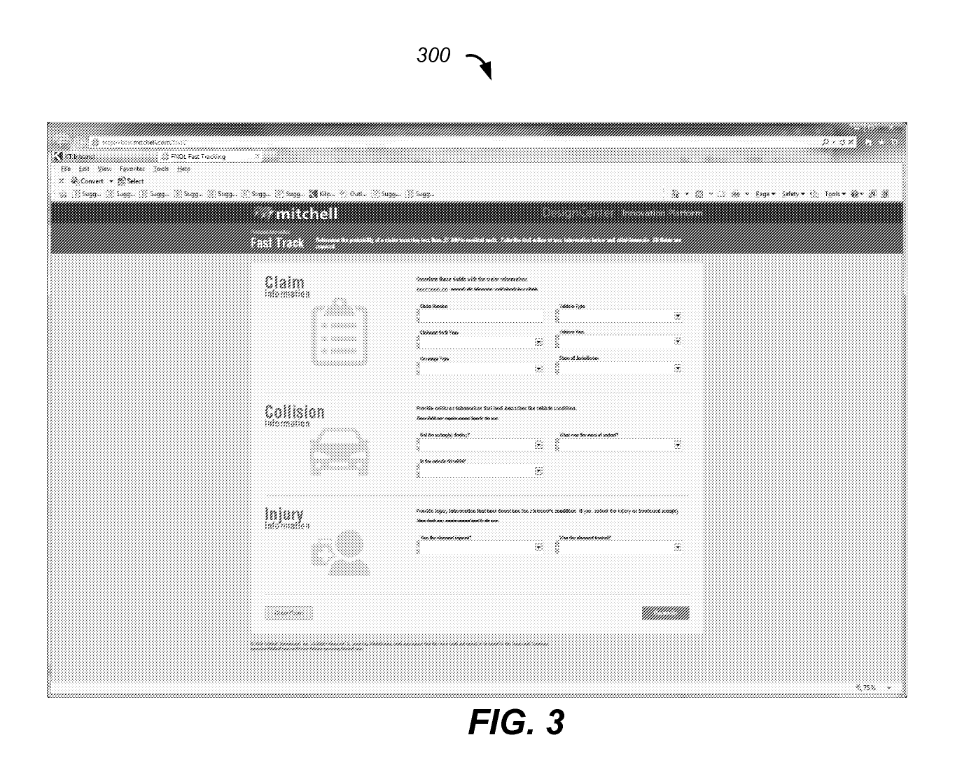

FIG. 2 is a flow diagram of the processing performed by the system 100 illustrated in FIG. 1. At the first operation, represented by the flow diagram box numbered 202, a user files or submits a claim to the system. An operation of the claim submission comprises responding to the filing by displaying user input screens on a computer device to elicit data that is needed for claim categorization. An example of a user input screen is provided in FIG. 3, as described further below. After the user input is received, the user may initiate categorization processing by selecting a “generate” display button or the like on the data input display of FIG. 3. In response, the system uses a categorization model in the categorization engine to predict the claim severity, as represented by the flow diagram box numbered 204.

FIG. 3 is an exemplary input interface for a user as shown on a computing device display 300 for receiving input in accordance with the system illustrated in FIG. 1. As illustrated in FIG. 3, inputs are collected that relate to claim information, collision information, and injury information. On the basis of these data inputs, the system generates a predicted severity for the claim, as indicated by a predicted dollar value that is expected to be paid out on the claim. The “generate” display button of the display 300 in the lower right corner is used to initiate the processing for generating the predicted severity value using the predictive model.

For example, the predictive model in the FIG. 1 system may utilize an equation from which a predictive value is calculated, wherein the equation takes the form in Equation (1) below:

P=e^{(a+bX)}/[1+e^{(a+bX)}] Equation (1)

Where the equation variables comprise:
a=(Intercept)
b=Variable
X=Estimate
e=exponent function
P=probability of being low severity

The value of P that will be a threshold value for processing as an expedited or “Fast Track” claim may be set depending on system resources, available skills, hisorial performance, geographic location, and the like. The variable values, and the P value for expedited processing, will typically be empirically determined, based on claims experience.

Inputs received from the user input screen (FIG. 3) may be received upon selection of drop-down menus or filling in boxes of the FIG. 3 display, and received inputs may be weighted as follows in Table 1:

TABLE 1

| Factor | Variable | Estimate |
|---|---|---|
| Intercept | (Intercept) | 7.5935 |
| Claimant | AgeAtLossAdj | 0.0350 |
| | log(AgeAtLossAdj) | (1.8014) |
| Coverage | CT_PI_IND | (0.0815) |
| Collision | isAirbagDeployed | (0.1337) |
| | aoi_Rear | (0.1974) |
| Vehicle | VT_Truck | 0.1773 |
| | VehicleAgeGT6 | (0.0119) |
| SOJ | ST_FL_IND | (0.4396) |
| Injury | dciSPRAIN | (0.4668) |
| | dciFRACTURE | (0.8219) |
| Emergency | PrCat02_Emergency_Ind | 0.6761 |
| Treatment | PrCat01_Emergency_Severe_Ind | (0.5211) |
| | PrCat01_Transportation_Ind | (0.3169) |
| Hospital | PrCat01_Hospital_Stay_Ind | (4.1264) |
| Stay | | |
| Initial | PrCat01_Scan_CT_Ind | (1.4955) |
| Procedures | PrCat01_Scan_MRI_Ind | (1.2795) |
| | PrCat01_Surgery_Ind | (0.5018) |
| | PrCat01_PhysicalTherapy_Ind | (0.7396) |
| | PrCat01_Lab_Ind | (0.7913) |
| Bodily | ba_count | (0.5539) |
| Injury | ba_head_neck | 0.2184 |
| | ba_shoulder_arm_hand | 0.2150 |
| | ba_trunk_back | 0.0748 |
| | ba_leg_foot | 0.2416 |
| Interactions | ST_FL_IND:dciSPRAIN | (0.9137) |
| | ST_FL_IND:ba_head_neck | (0.9037) |
| | ST_FL_IND:ba_trunk_back | (0.1105) |
| | ba_head_neck:ba_trunk_back | (0.4790) |
| | ST_FL_IND:ba_head_neck:ba_trunk_back | 0.5738 |

All the variables in Table 1 except AgeAtLossAdj and ba_count are binary (1/0 for true/false). The variable ba_count is the count of the number of body areas identified. The age adjustment is typically the substitution of the mean age (44) when an unreasonable age was calculated from the captured birthdate. The interactions are derived by multiplying the combined variables (xxx:yyy:zzz), so the interaction is true only when all of its components are true.

As noted, the received inputs may comprise variables from which the predictive model computes a predicted claim severity. The inputs that may be solicited for entry by the user through the FIG. 3 input display may comprise, for example, the questions and exemplary input values indicated below in Table 2:

TABLE 2

| 1. | Describe the collision_{——}_{——}_{——} | |
|---|---|---|
| | a. | Collision: Point of Impact (Front, Rear, Underneath, |
| | | Side, or Rollover) |
| | b. | Collision: Did the Airbag Deploy? (Yes/No) |
| | c. | Collision: Was the Vehicle Drivable? (Yes/No) |
| 2. | Were you injured? (Yes/No) If yes, answer below | |
| | a. | Describe your injury_{——}_{——}_{——} |

| | |
|---|---|
| i. | Injury: Sprain (Yes/No) |
| ii. | Injury: Fracture (Yes/No) |

| | |
|---|---|
| b. | Which areas of your body are injured?_{——}_{——}_{——} |

| | |
|---|---|
| i. | Head or Neck (Yes/No) |
| ii. | Shoulder, Arm, or Hand (Yes/No) |
| iii. | Trunk or Back (Yes/No) |
| iv. | Leg, Ankle, or Foot (Yes/No) |
| v. | Joints or Bones (Yes/No) |

| | |
|---|---|
| c. | Have you already been treated?_{——}_{——}_{——} |

| | |
|---|---|
| i. | Ambulance (Yes/No) |
| ii. | Emergency Room (Yes/No) |
| iii. | Critical Care (Yes/No) - life flight, ECU, etc. |
| iv. | Overnight Hospital Stay (Yes/No) |
| v. | Surgery (Yes/No) |
| vi. | Physical Therapy (Yes/No) |
| vii. | CT Scan (Yes/No) |
| viii. | MRI Scan (Yes/No) |
| ix. | Lab Work (Yes/No) |

| 3. | Additional facts regarding the coverage | |
|---|---|---|
| | a. | Claimant: Date of Birth |
| | b. | Coverage: Type (PIP or MedPay) - the current scoring |
| | | model is for 1st party claims only |
| | c. | Coverage: State of Jurisdiction |
| | d. | Vehicle: Model Year |
| | e. | Vehicle: Type (Truck, Car, SUV, Van, or Motorcycle) |

Some of the input values will comprise “yes” or “no” responses, other input value may comprise alphanumeric inputs from the user.

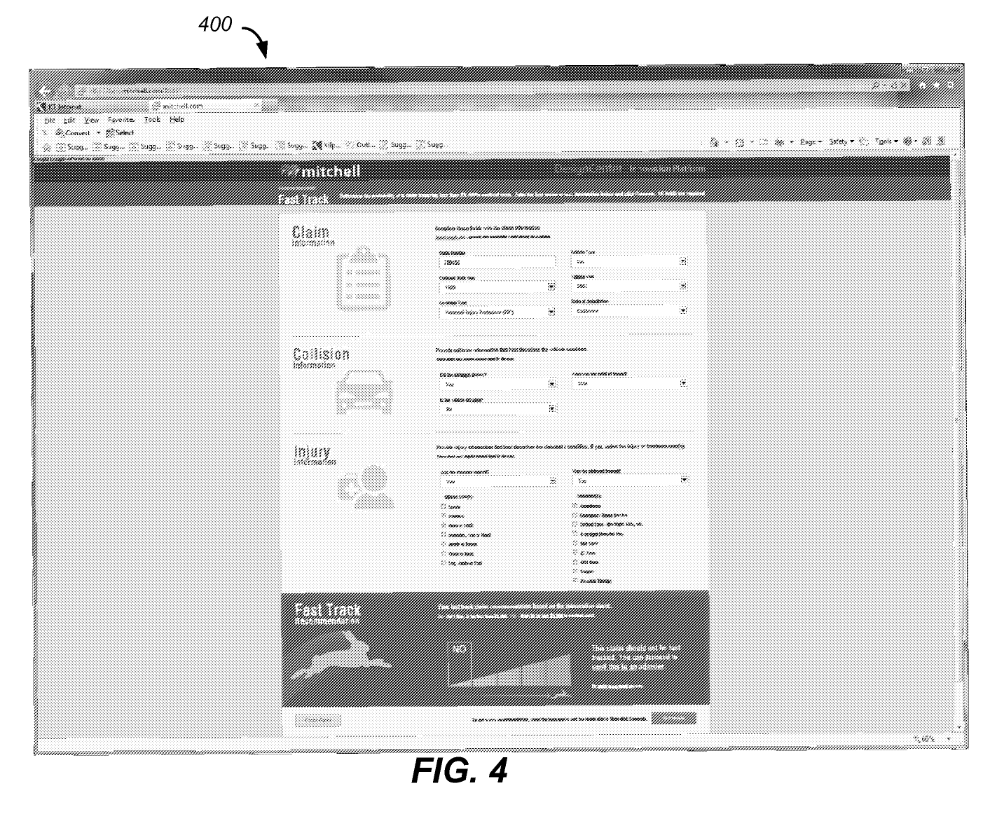

FIG. 4 is an exemplary report 400 as displayed on a computing device after receiving user input for a claim and selecting “generate” on the input screen, in accordance with the system illustrated in FIG. 1. The “fast track” decision is displayed as “NO” because of the predicted severity of the claim.

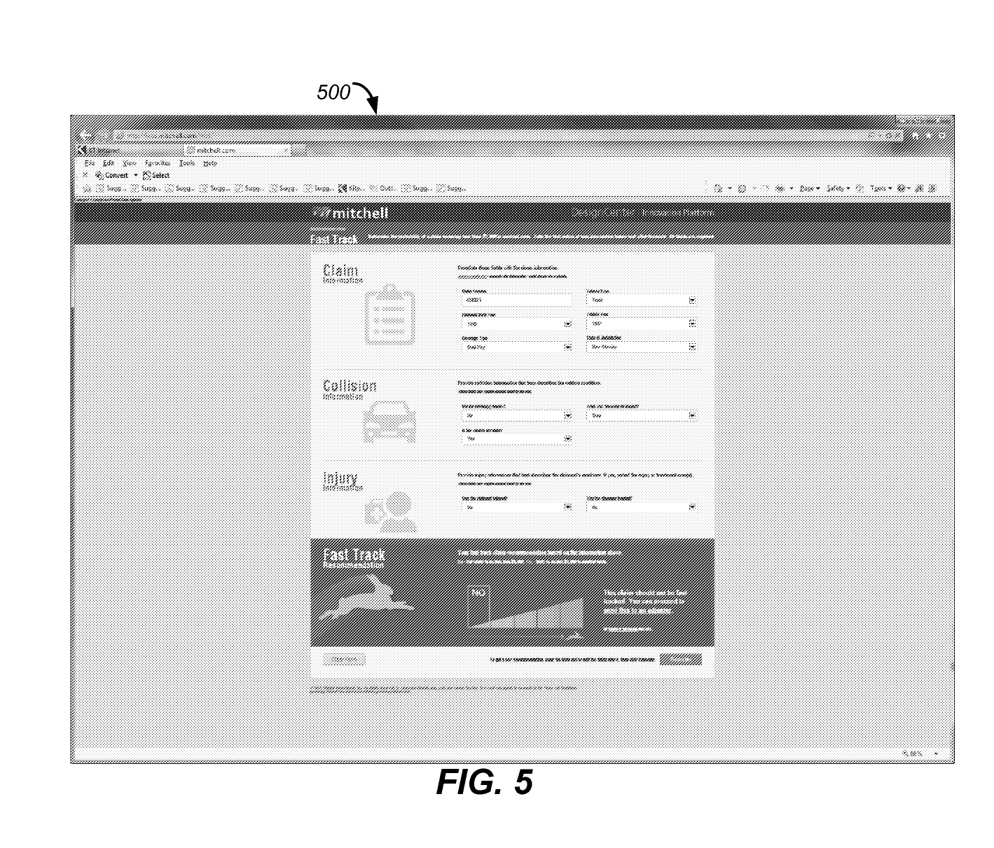

FIG. 5 is another exemplary report 500 as displayed on a computing device after receiving user input for a claim and selecting “generate” on the input screen, in accordance with the system illustrated in FIG. 1. The “fast track” decision is displayed as “NO” because of the predicted severity of the claim.

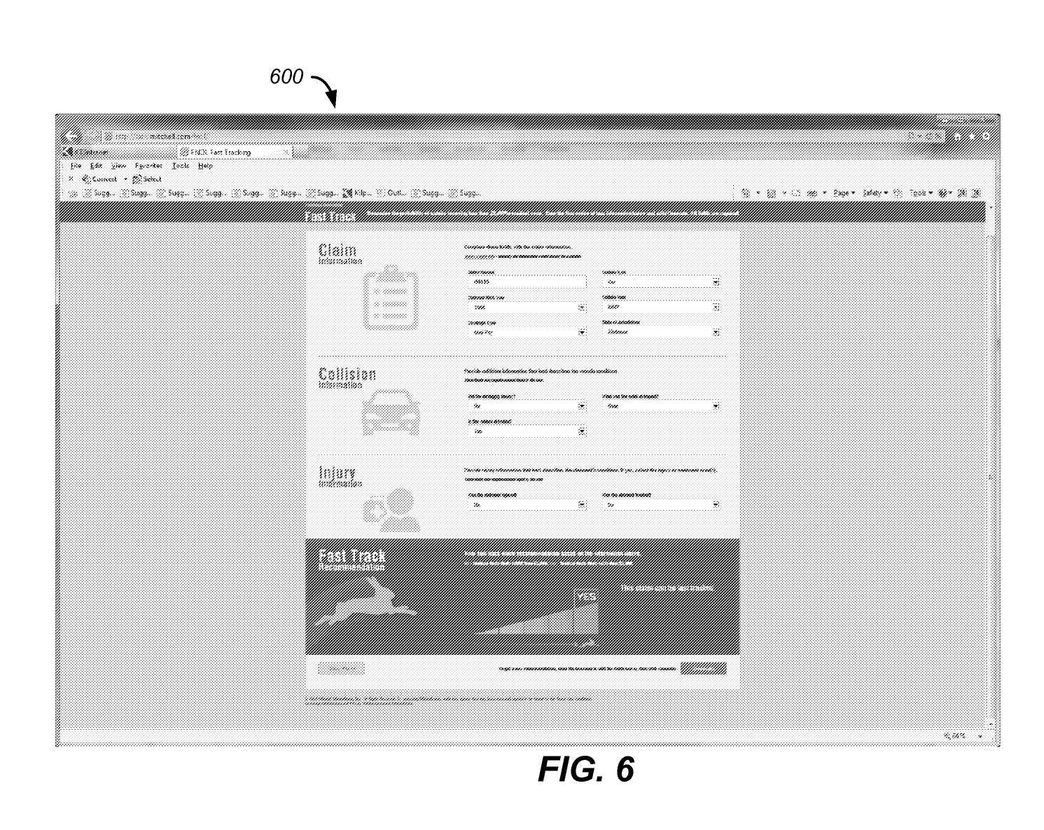

FIG. 6 is an exemplary report 600 as displayed on a computing device after receiving user input for a claim and selecting “generate” on the input screen, in accordance with the system illustrated in FIG. 1. The “fast track” decision is displayed as “YES” because of the predicted severity of the claim.

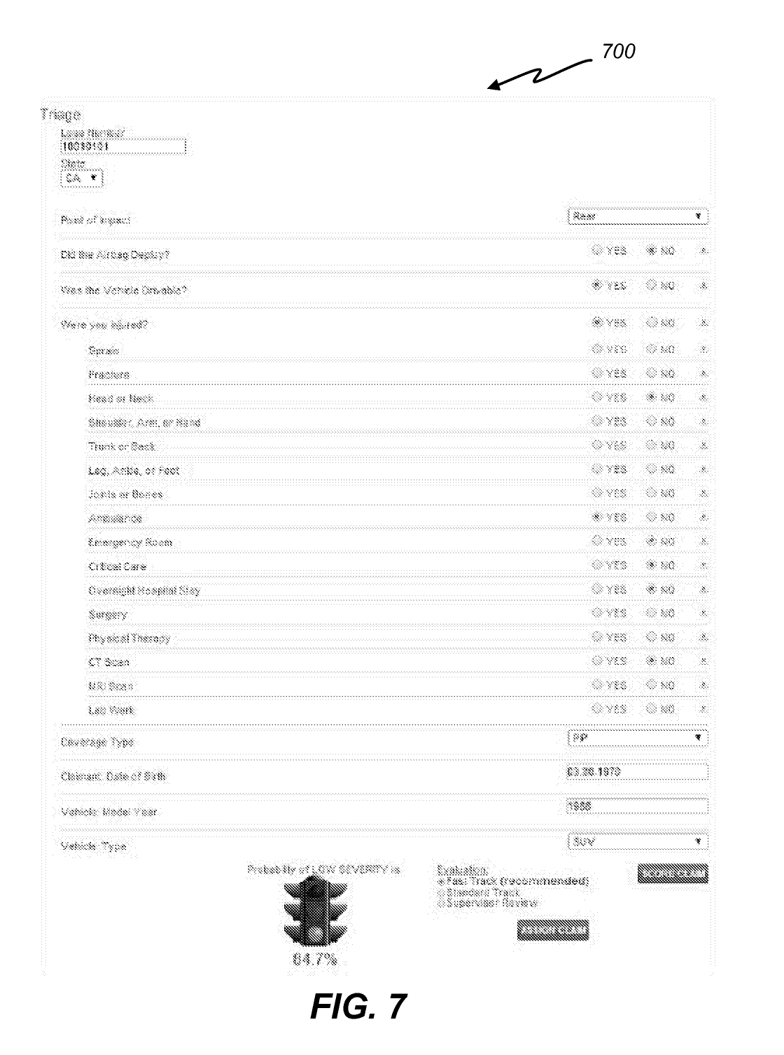

FIG. 7 is an exemplary user input and report screen 700 as displayed on a computing device after receiving user input for a claim and after selecting “generate” on the input screen, in accordance with the system illustrated in FIG. 1. FIG. 7 provides an alternate embodiment of the display shown in FIG. 6. The “fast track” decision at the bottom of the display screen in FIG. 7 is displayed as “YES” because of the predicted severity of the claim, which indicates 84.7% as the predicted probability of a low severity claim.

Additional Considerations

Attached to this application are appendixed that include further description of the system configuration and processing. The system operation will be better understood with reference to the attached appendixes, which include Appendix A, “FNOL Medical Triage”, Appendix B, “Research Notes”, and Appendix C, “ClaimIQ Recommendation Engine .NET: Architecture & Design”. The contents of these appendixes are incorporated herein, by reference.

Hardware Configurations

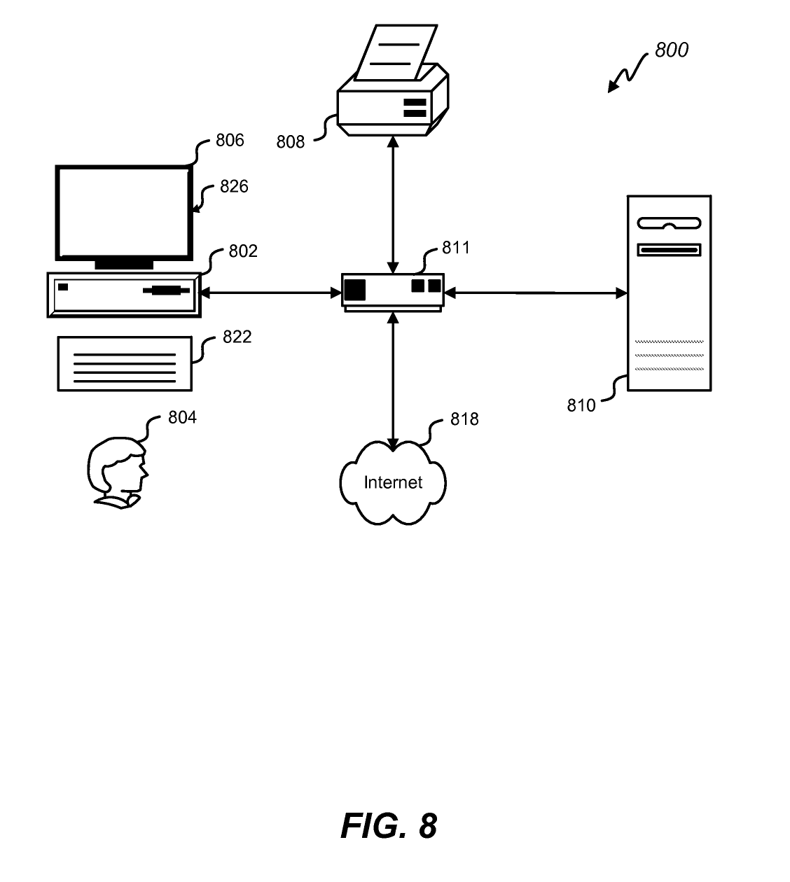

Referring next to FIG. 8, an exemplary environment with which embodiments may be implemented is shown with a computer system 800 that can be used by a designer 804 to design, for example without limitation, electronic designs. The computer system 800 can include a computer 802, keyboard 822, a network router 811, a printer 808, and a monitor 806. The monitor 806, processor 802, and keyboard 822 are part of a computer system 826, which can comprise a laptop computer, desktop computer, handheld computer, tablet computer, mainframe computer, and the like. The monitor 806 can comprise a CRT, flat screen display, or the like.

A system user 804 can input commands into the computer 802 using various input devices, such as a mouse, keyboard 822, track ball, touch screen, and the like. If the computer system 800 comprises a mainframe computer, then the user 804 can access the computer 802 using, for example without limitation, a terminal or terminal interface. Additionally, the computer system 826 may be connected to the printer 808 and a server 810 using a network router 811, which may connect to the Internet 818 or a WAN. The lines with arrows indicate data communication paths in the system 800, such as an intranet, data bus, or network generally.

The server 810 may, for example without limitation, be used to store additional software programs and data. In some embodiments, software implementing the systems and methods described herein can be stored on a storage medium in the server. Thus, the software can be run from the storage medium in the server 810. In another embodiment, software implementing the systems and methods described herein can be stored on a storage medium in the computer 802. Thus, the software can be run from the storage medium in the computer system 826. Therefore, in this embodiment, the software can be used whether or not the computer 802 is connected to the network router 811. The printer 808 may be connected directly to the computer 802, in which case, the computer system 826 can print whether or not it is connected to the network router 811.

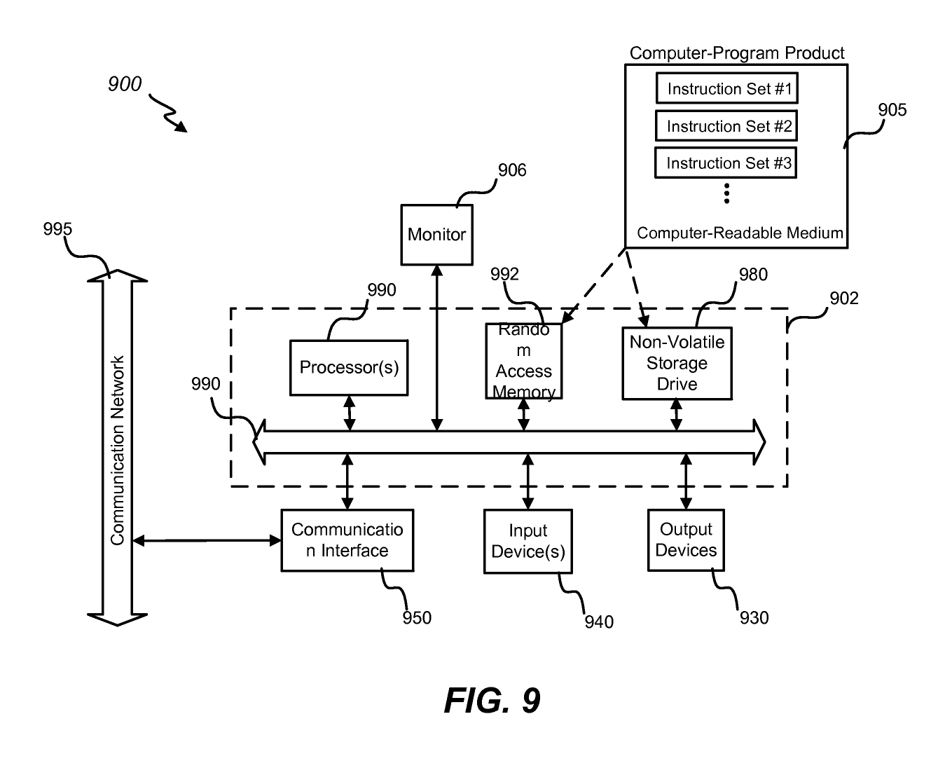

With reference to FIG. 9, an embodiment of a special-purpose computer system 900 is shown. The above methods may be implemented by computer-program products that direct a computer system to perform the actions of the above-described methods and components. Each such computer-program product may include sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system, it is transformed into the special-purpose computer system 900 such as illustrated in FIG. 9.

The special-purpose computer system 900 includes a computer 902, a monitor 906 coupled to the computer 902, one or more additional user output devices 930 (optional) coupled to the computer 902, one or more user input devices 940 (e.g., keyboard, mouse, track ball, touch screen) coupled to the computer 902, an optional communications interface 950 coupled to the computer 902, a computer-program product 905 stored in a tangible computer-readable memory that may be placed in the computer 902. The computer-program product 905 includes instructions that, when executed by the computer, direct the system 900 to perform the above-described operations. The computer 902 may include one or more processors 990 that communicate with a number of peripheral devices via a bus subsystem 990. These peripheral devices may include a user output device(s) 930, a user input device(s) 940, a communications interface 950, and a storage subsystem, such as random access memory (RAM) 992 and a non-volatile storage drive 980 (e.g., disk drive, optical drive, solid state drive), which are forms of tangible computer-readable memory.

The computer-program product 905 may be stored in the non-volatile storage drive 980 or another computer-readable medium accessible to the computer 902 and loaded into the memory 992. Each processor 990 may comprise a microprocessor, such as a microprocessor from Intel® or Advanced Micro Devices, Inc.®, or the like. The computer 902 runs or executes an operating system that supports an operating environment and handles the communications of the computer-program product with the above-noted components, as well as the communications between the above-noted components in support of the computer-program product, in support the computer-program product. Exemplary operating systems include Windows® or the like from Microsoft® Corporation, Solaris® from Oracle®, LINUX, UNIX, and the like.

The user input devices 940 include all possible types of devices and mechanisms to input information to the computer system 902. These may include a keyboard, a keypad, a mouse, a scanner, a digital drawing pad, a touch screen incorporated into the display, audio input devices such as voice recognition systems, microphones, and other types of input devices. In various embodiments, the user input devices 940 are typically embodied as a computer mouse, a trackball, a track pad, a joystick, wireless remote, a drawing tablet, a voice command system. The user input devices 940 typically allow a user to select objects, icons, text and the like that appear on the monitor 906 via a command such as a click of a button or the like. The user output devices 930 include all possible types of devices and mechanisms to output information from the computer 902. These may include a display (e.g., the monitor 906), printers, non-visual displays such as audio output devices, and the like.

The communications interface 950 provides an interface to other communication networks 995 and devices and may serve as an interface to receive data from and transmit data to other systems, WANs and/or the Internet 818 (see FIG. 8). Embodiments of the communications interface 950 typically include an Ethernet card, a modem (telephone, satellite, cable, ISDN), a (asynchronous) digital subscriber line (DSL) unit, a FireWire® interface, a USB® interface, a wireless network adapter, and the like. For example without limitation, communications interface 950 may be coupled to a computer network, to a FireWire® bus, or the like. In other embodiments, the communications interface 950 may be physically integrated on the motherboard of the computer 902, and/or may be a software program, or the like.

The RAM 992 and non-volatile storage drive 980 are examples of tangible computer-readable media configured to store data such as computer-program product embodiments of the disclosure, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. The RAM 992 and the non-volatile storage drive 980 may be configured to store the basic programming and data constructs that provide the functionality of various embodiments of the present disclosure, as described above.

Software instruction sets that provide the functionality of the present disclosure may be stored in the RAM 992 and non-volatile storage drive 980. These instruction sets or code may be executed by the processor(s) 990. The RAM 992 and non-volatile storage drive 980 may also provide a repository to store data and data structures used in accordance with the present disclosure. The RAM and non-volatile storage drive may include a number of memories including a main random access memory (RAM) to store of instructions and data during program execution and a read-only memory (ROM) in which fixed instructions are stored. The RAM and non-volatile storage drive may include a file storage subsystem providing persistent (non-volatile) storage of program and/or data files. The RAM 992 and non-volatile storage drive 980 may also include removable storage systems, such as removable flash memory.

The bus subsystem 990 provides a mechanism to allow the various components and subsystems of the computer 902 to communicate with each other as intended. Although the bus subsystem 990 is shown schematically as a single bus, alternative embodiments of the bus subsystem may utilize multiple busses or communication paths within the computer 902.

Specific details are given in the above description to provide a thorough understanding of the embodiments. However, it is understood that the embodiments may be practiced without these specific details. For example without limitation, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example without limitation, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example without limitation, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning.

What is claimed is:

1. A computer-implemented method for categorization of claims, the method comprising:
receiving a claim from a system user;
generating a predicted claim severity in response to user inputs of the received claim applied to a prediction model calculation;
determining further processing of the received claim in response to the predicted claim severity.

2. The computer-implemented method of claim 1, wherein the user inputs include data relating to claim information, collision information, and injury information.

3. A system comprising:
a user interface component that receives a claim from a system user;
a categorization engine that responds to user inputs of the received claim and performs calculation to perform operations comprising
generating a predicted claim severity in response to user inputs of the received claim applied to a prediction model calculation, and
determining further processing of the received claim in response to the predicted claim severity.

4. The system of claim 3, wherein the user inputs include data relating to claim information, collision information, and injury information.

5. A computer program product, tangibly embodied in a non transitory machine-readable storage medium, the medium including instructions configured to cause a data processing system to perform operations comprising:
receiving a claim from a system user;
generating a predicted claim severity in response to user inputs of the received claim applied to a prediction model calculation;
determining further processing of the received claim in response to the predicted claim severity.

6. The computer program product of claim 5, wherein the user inputs include data relating to claim information, collision information, and injury information.
